(19) United States
(12) Patent Application Publication
(10) Pub. No.: US 2011/0180707 A1
(43) Pub. Date: Jul. 28, 2011

(54) MICROSAMPLING APPARATUS AND SAMPLING METHOD THEREOF

(76) Inventors: Takashi Iwanami, Tokyo (JP); Kazuhiko Horikoshi, Yokohama (JP)

(21) Appl. No.: 13/014,054

(22) Filed: Jan. 26, 2011

(30) Foreign Application Priority Data
Jan. 27, 2010 (JP) 2010-014995

(51) Int. Cl. G01N 23/00

(52) U.S. Cl. 250/307; 250/310

(57) ABSTRACT

A microsampling apparatus having a mechanism for enabling observation of a specimen and for contacting a potential-controllable conductive terminal with a sampling area and a sampling method thereof are provided. The mechanism includes an operation mechanism for precisely controlling, during the observation, a conductive terminal for contact with a periphery of the sampling area and movement of the terminal, a potential control mechanism for applying a voltage to the terminal, and a mechanism for coupling the terminal to ground and to the potential control mechanism. Contacting the terminal with a vicinity of the specimen allows charged particles that are created during the observation and sampling to escape via an earth lead. This makes it possible, in analysis preprocessing of a small insulator specimen of about 1 μm which causes device defects, to lessen electrification risks, thereby enabling sampling of only the target object without mixture of a surrounding base material.

### INCORPORATION BY REFERENCE

The present application claims priority from Japanese application JP 2010-014995 filed on Jan. 27, 2010, the content of which is hereby incorporated by reference into this application.

### BACKGROUND OF THE INVENTION

The present invention relates to a microsampling apparatus for isolating and sampling a small object on a workpiece substrate, and also relates to a sampling method thereof.

In electronic device manufacturing/fabrication processes, it is required to continue to mass-produce nondefective products. Due to the fact that the number of products is extra-large, the occurrence of a defect leads to a decrease in product yield or to stoppage of a production line(s), which will greatly affect the commercial profit. For this reason, efforts are made to eliminate defective products and promote cause investigation. Practically, the identification of very small foreign matter that causes detection is carried out by a variety of analyses. In such analyses, the sampling and isolation of foreign matter from a substrate becomes important in order to improve the analytical precision. In cases where the isolation is impossible, it is unavoidable to analyze both the substrate and the foreign matter simultaneously, resulting in an extreme degradation of the signal-to-noise (S/N) ratio of an aimed signal. For instance, although it is considered that the use of the micro Fourier transform infrared ray (FT-IR) spectroscopy is effective for the analysis of small organic foreign matter residing on electronic devices, this micro FT-IR spectroscopy is typically about 10 μm in spatial resolution and thus suffers from a demerit which follows: when an attempt is made to analyze a foreign object with its size of several micrometers, the information of those other than the foreign matter occupies a major part, resulting in the information of the foreign matter per se hiding in the background, which leads to the lack of an ability to identify the foreign matter. However, if it is possible to isolate the foreign matter, only the information of the target foreign matter is obtainable, resulting in an appreciable increase in analysis precision.

For the sampling and isolation of such micro-foreign matter, commercially available micromanipulator systems are usually used.

In prior known microsampling systems of the type using an optical microscope, because of the use of this optical microscope, when performing the sampling of an object with its size less than or equal to 10 μm as an example, a sampling instrument or tool used therefor is shifted in position toward outside of the range of observation due to the occurrence of out-of-focus to be caused by shallowness of the focal depth of a lens. This leads to increased difficulty in operation.

One solution to the above-stated problem is to use a scanning electron microscope (SEM) which is larger in focal depth than optical microscopes. Observation and fabrication processing are performed using the SEM equipment in a way as disclosed, for example, in JP-A-11-271636, JP-A-2001-198896, and JP-A-2001-88100.

### SUMMARY OF THE INVENTION

However, in view of the fact that the SEM is designed to use charged particles, a specimen or “sample” made of an electrically insulative material can be electrified by the irradiation of an electron beam in the process of observing and/or sampling such insulator specimen. The electrification can sometimes cause degradation of the quality of an observation image and also the occurrence of quantitative and qualitative deteriorations of signals of secondary electrons and reflected electrons or the like along with undesired scattering of a constituent material(s) of the insulator specimen.

These problems become more noticeable as the insulator specimen becomes higher in electrical resistivity. This is caused by the fact that charged particles with the reverse polarity tend to stay on-site, which are generated by the release of either electrical changes of charged particles being irradiated onto an insulator specimen or secondary electrons produced from the insulator specimen. Traditionally, for those problems arising from the electrification, the following techniques or schemes have been employed either independently or in a combined manner.

(a) Lessening the dose of an electron beam.

(b) Forming a conductive thin-film on the surface of a specimen.

(c) Irradiating a beam of charged particles that are opposite in polarity to the charge electrified.

Unfortunately, the above-stated methods (a) to (c) are faced with problems which follow.

Use of the method (a) would result in a decrease in signal amount of secondary electrons, which leads to a likewise decrease in observation performance.

Use of the method (b) results in an unwanted change in composition of the specimen of interest. This causes undesired mixture of an extra signal as derived from the conductive thin-film during analysis after the sampling, thereby complicating the analyzation of a result.

When using the method (c), it is a must to irradiate a specific amount of charged particles which amount is carefully determined to negate or “cancel out” the charge to be generated; however, the surface potential varies with time, letting the signal amount of secondary electrons become unstable. Consequently, preliminary experimentation for determining a suitable irradiance level of charge is needed. Furthermore, in case the charged particles to be irradiated are ions, surface sputtering can often take place with a risk of the cutting of interatomic bonding.

It is therefore a first object of the present invention to achieve, in a sampling apparatus having an observation system of the type using charged particles, reduction of electrification of an electrically insulative specimen at any given positions on the specimen, thereby to assure observation performance.

It is a second object of this invention to perform, in the sampling apparatus having the charged particle-using observation system, sampling of a specimen while suppressing specimen scattering otherwise occurring due to electrification.

To attain either one of the foregoing objects, a microsampling apparatus which has a mechanism for enabling observation of a specimen and for contacting a potential-controllable terminal made of an electrically conductive material with a sampling area and a sampling method thereof are provided. The mechanism is generally made up of an operation mechanism for precisely controlling, during the observation, a conductive terminal for contact with a surrounding part of the sampling area and movement of this terminal, a potential control mechanism for applying a voltage to the terminal, and a mechanism for connecting the terminal to the ground or “earth” and also to the potential control mechanism. By contacting the terminal with either the specimen or a part in close proximity thereto, those charged particles that are created in the observation and sampling processes are forced to escape via an earth lead. A conceptual diagram of this mechanism is shown in FIG. 1.

The operation of bringing the terminal into contact with the specimen or its nearby part is performed with the aid of a control device having a coarse motion control mechanism and a fine or “micro” motion control mechanism.

The conductive terminal for suppression of the electrification is constituted from a structure having a needle-like shape or any other suitable shapes resembling thereto. It should be noted that although one example of the shape and structure of the terminal is shown in FIG. 1, this is not to be construed as limiting the invention.

According to this invention, it is possible to achieve the sampling of an insulator specimen on an insulative substrate even in the state that an electron beam is irradiated thereonto.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram depicting, in longitudinal cross-section, a microsampling apparatus in accordance with one embodiment of the present invention.

FIG. 2 is a flow diagram of a sampling process in accordance with one embodiment of this invention.

FIG. 3 is a diagram showing a side view of a substrate for explanation of a scanning electron microscopy (SEM) observation process in accordance with one embodiment of the invention.

FIG. 4 is a diagram for explanation of electrification suppression in accordance with one embodiment of the invention.

FIG. 5 is a diagram for explanation of a specimen cutting process in accordance with one embodiment of the invention.

FIG. 6 is a diagram for explanation of a specimen sampling step in accordance with one embodiment of the invention.

### DETAILED DESCRIPTION OF THE EMBODIMENTS

Currently preferred embodiments of this invention will be described with reference to the accompanying views of the drawings below.

### Embodiment 1

One important feature of a microsampling apparatus in accordance with this embodiment is that the apparatus has a terminal for electrification suppression and specimen sampling to thereby enable execution of the sampling of an electrically insulative specimen while at the same time performing electron microscope (EM) observation. More specifically, the microsampling apparatus performs observation and cutting processes while suppressing the electrification and performs electrostatic sampling of an insulative micro-specimen which is slightly electrified.

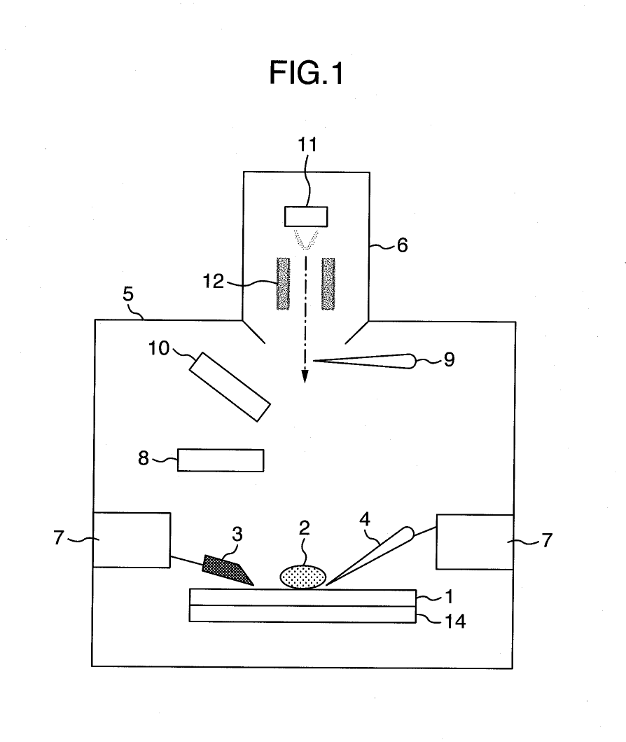

FIG. 1 is a diagram showing, in schematic cross-section, a configuration of the first embodiment of this invention. Reference numeral 1 of FIG. 1 designates an electrically insulative substrate; numeral 2 indicates a small or “micro” insulator specimen on the insulative substrate 1; 3 denotes a cutting tool; 4 is a terminal; 5, a specimen/sample chamber; 6, an electron gun; 7, a manipulator for operating the cutting tool 3 and the terminal 4; 8, a secondary electron detector; 9, a reflected electron detector; 10, an energy dispersive X-ray (EDX) detector; 11, an electron source; 12, an electrode; 14, a sample support stage. The terminal 4 and the cutting tool 3 are coupled to an end of the manipulator 7 which is operable from outside. The terminal 4 is made of a metal, for example. The microsampling apparatus also has a monitor device (not depicted) which visually displays, as an image, secondary electrons that are detected by the reflected electron detector 9 after irradiation of an electron beam from the electron gun 6 and reflection at the specimen. It is noted here that those constituent parts or components which are not directly involved with the explanation of this invention, e.g., an evacuation system and others, are eliminated from the illustration of FIG. 1.

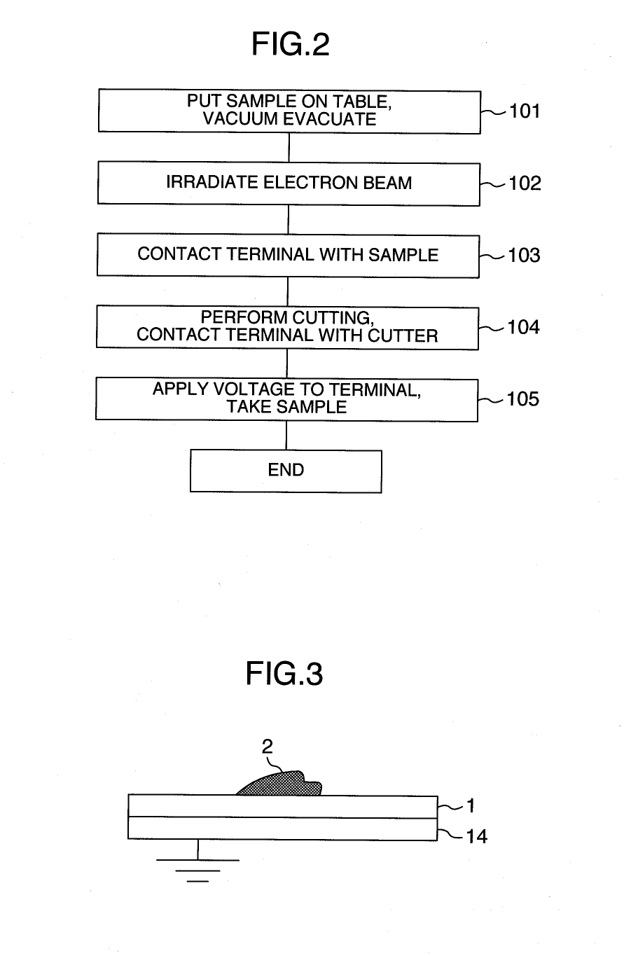

A process of sampling the micro insulator specimen 2 in this embodiment will be set forth with reference to a flow chart of FIG. 2. After having situated the insulative substrate 1 with the micro insulator specimen 2 firmly fixed and attached thereto on the sample stage 14, the interior of the sample chamber 5 is evacuated to a predetermined degree of vacuum (at step 101). Then, the electron gun 6 is activated to produce a beam of electrons, which is focus-controlled by a lens system and then irradiated onto a top surface of the insulative substrate 1 (at step 102). Here, the specimen and its surrounding part in the process of scanning electron microscope (SEM) observation is shown in FIG. 3. Preferably, an acceleration voltage of the electron beam is set to fall within a range of 500V to 2 kV, which makes it possible to obtain excellent image resolution while simultaneously lessening or minimizing damage to the micro-insulator specimen 2. Then, the electron beam is deflected in such a way as to achieve the scanning on the surface of the insulative substrate 1. At this time, secondary electrons generated from the surface of insulative substrate 1 are measured by the detector 9, thus obtaining a secondary electron image on the specimen surface. This secondary electron image is used to adjust the position of the sample stage 14 to thereby determine a portion to be subjected to the sampling. Preferably, the scanning speed is set to range from 0.5 to 2 frames per second for enabling execution of the intended specimen observation while retaining an increased S/N ratio. A magnifying power at this time is about several tenfold in low magnification. Preferably, a distance (called the working distance) between the specimen and the end of a lens barrel of the electron gun 6 is set to fall within a range of 15 mm to 30 mm, which makes it possible to provide a space wide enough to introduce thereinto the cutting tool 3 and terminal 4 and enable execution of the observation.

While the electron beam is being irradiated with respect to the insulator at this time, the electron beam becomes higher in irradiation density when the observation is done at a high magnification of 10,000-fold which is necessary for precise positioning, resulting in dominant appearance of the influence of electrification on the surface, i.e., distortion of a secondary electron image in a desired observation area, a change in contrast, and scattering of the micro insulator specimen 2.

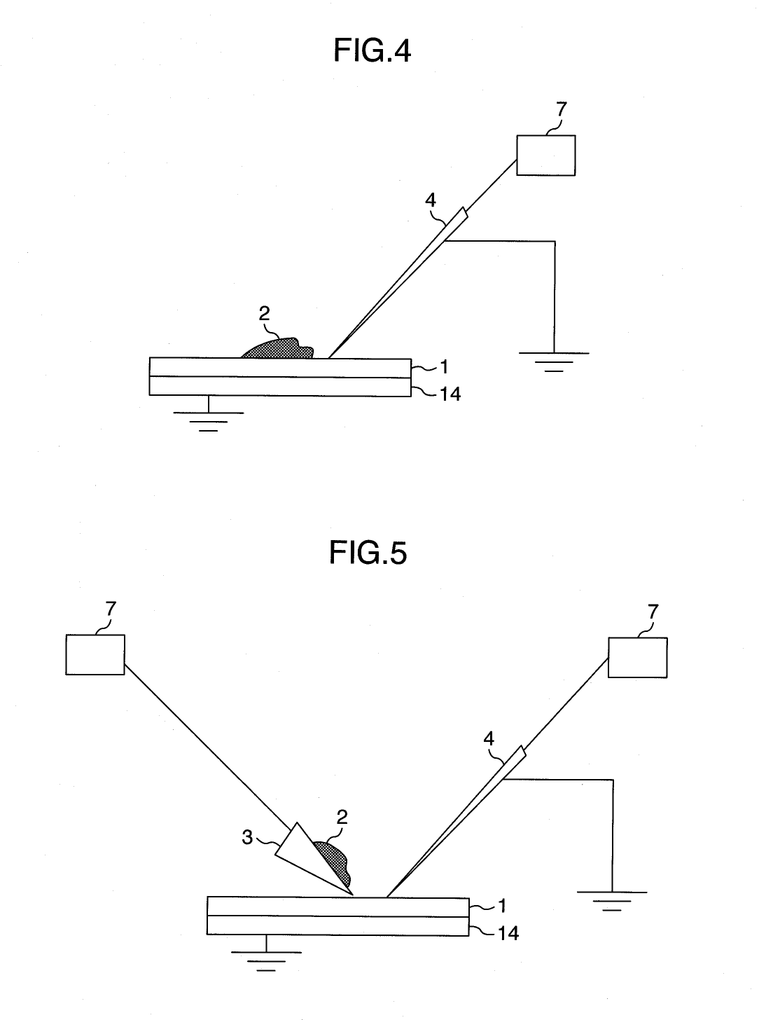

Here, as shown in FIG. 4, the end of the conductive terminal 4 is brought into contact with the substrate 1 at a portion in close proximity to the insulator specimen 2 within the observation area whereby an electrification-produced charge is forced to escape to thereby suppress or prevent the electrification (at step 103 of FIG. 2). The terminal 4 is provided at the manipulator 7 and is coupled to ground. A stroke of the manipulator 7 is set to 5 mm or more to ensure that the operability or manipulability during cutting and sampling processes is kept excellent. The movement accuracy is set at 0.5 nm.

Next, an explanation will be given of the isolation of the micro insulator specimen 2 (at step 104 of FIG. 2). An isolation step is shown in FIG. 5. Firstly, while observing a secondary electron image, the manipulator 7 is operated to make the cutting tool 3 come close to a very nearby portion of the micro insulator specimen 2. Next, the cutting tool 3 is driven to move its blade edge so that the micro insulator specimen 2 becomes detached from the insulative substrate 1. Regarding a technique for driving the manipulator 7, any kind of method or scheme is employable insofar as it offers an ability to move by an infinitesimal distance, such as a stepper motor scheme, piezoelectric scheme, etc. The cutting tool 3 is arranged to have a degree of hardness equivalent to the Mohs hardness 6 or above. The cutting tool 3 is typically made of diamond or sapphire. The cutting tool 3 has a blade angle which is determined in view of both the cutting performance and the machinability for fabrication of the blade edge—preferably, 20 to 40 degrees. The cutting tool 3 may be designed to have any one of various shapes, such as a flat blade, double-ended blade, single-ended blade or the like. Additionally, the cutting tool 3 may be made of other materials, including but not limited to zirconia and ruby.

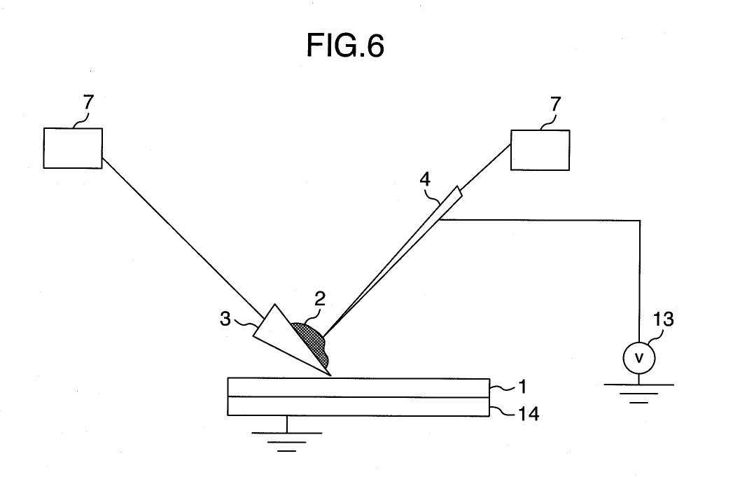

In the case where diamond and sapphire which are high in hardness are used for the cutting tool 3, these are electrically insulative materials so that electrification takes place as a result of the electron beam irradiation. Therefore, the micro insulator specimen 2 that was isolated and put on the cutting tool 3 is electrified and, in some cases, scatters due to repulsion or “repelling” between the electrified specimen 2 and the cutting tool 3. The polarity and quantity of such electrification is determined by a release ratio of secondary electrons to the electron irradiation amount. An example is that the specimen is electrostatically charged to have the positive polarity in a case where the amount of secondary electrons produced is greater than the electron irradiation amount. Accordingly, the terminal 4 which was in contact with the substrate 1 is moved to thereby transfer the micro insulator specimen 2 on the cutting tool 3 to the terminal 4 (at step 105). At this time, a negative voltage is applied to the terminal 4 by a potential control mechanism 13, thereby electrostatically sampling a slightly positively electrified foreign object. The voltage potential of the terminal 4 is adequately varied in a way depending upon the electrification polarity of the specimen 2. A sampling step is shown in FIG. 6. The terminal 4 having its end attached to the micro insulator specimen 2 is driven to go back away from the sampling part whereby the sampling is completed.

### Embodiment 2

An explanation will next be given of a method for picking up foreign matter which is negatively electrifiable upon irradiation of an electron beam. The steps 101 to 103 of the above-stated embodiment are the same. At step 104, the diamond-made cutting tool 3 provided at the manipulator 7 is used to cut and isolate a foreign object (specimen 2) from the substrate 1 in a similar way to the embodiment 1. The micro insulator specimen 2 which is mounted on the cutting tool 3 is electrified to have the negative polarity. At step 105, the terminal 4 that was brought into contact with the substrate 1 is driven to move toward the micro insulator specimen 2 on the cutting tool 3; then, a positive voltage is applied to the terminal 4 by the potential control mechanism 13 so that the negatively electrified foreign object 2 is electrostatically picked up at the end of the terminal 4. As the electrification quantity of the foreign object 2 depends upon the material and shape of this foreign matter, there is a case where the foreign object 2 does not readily transfer to the terminal 4. If this is the case, the voltage being applied to the terminal 4 is gradually increased in potential, thereby achieving application of a voltage which is potentially high enough to force the foreign matter 2 to move to the terminal 4.

### Embodiment 3

Next, an explanation will be given of an example having as the foreign matter pickup mechanism a tweezers-shaped grasp/holding mechanism consisting essentially of two arms. The micro-specimen grasp/hold mechanism is a tool or instrument for plucking up a very small thing with its size being on the order of submicrometers, which tool is built in the manipulator 7 and operates to pick up a small thing by utilizing the phenomenon that the voltage application to an electrostatic actuator causes the micro specimen grasp/hold mechanism to become narrower in distance between ends thereof.

In this embodiment, there will be explained (1) a merit of cutting performance in the case of the grasp/hold mechanism being used and (2) a merit of scattering prevention in the case of the grasp/hold mechanism being used. (1) A specimen large in brittleness sometimes breaks or wrecks during cutting, resulting in failure to perform sampling. By surely grasping such brittle specimen by the grasp/hold mechanism in advance, it is possible to readily perform the sampling. (2) In cases where the micro insulator specimen 2 that was cut behaves to scatter dynamically rather than electrostatically after the cutting process, the micro insulator specimen 2 can disappear out of an observer's eyesight. To avoid this and for the purposes of prevention of such flying, the micro insulator specimen 2 is plucked by the micro specimen grasp/hold mechanism, and then the cutting process is performed. This makes it possible to prevent unwanted scattering.

In this embodiment, the apparatus has the micro-specimen grasp/hold mechanism in place of the terminal 4 as used in the embodiments 1 and 2. This grasp/hold mechanism is controllable in its potential by the potential control mechanism 13. Regarding a procedure of the sampling, its vacuum evacuation and electron beam irradiation steps are the same as the steps 101 and 102 of the embodiment 1. After the electron beam irradiation, the foreign object 2 is picked up and held by the micro-specimen grasp/hold mechanism. At this time, electrical charge carriers that are electrified to the specimen 2 are forced by the grasp/hold mechanism to escape to thereby suppress electrification. Thereafter, in a similar way to the step 104 of the embodiment 1, the cutting tool 3 is used to cut the specimen 2. At this time, the cutting-applied specimen 2 is firmly seized by the grasp/hold mechanism; so, the sampling is completed by letting this mechanism return to its standby position without having to perform the step 105 of the embodiment 1.

It should be further understood by those skilled in the art that although the foregoing description has been made on embodiments of the invention, the invention is not limited thereto and various changes and modifications may be made without departing from the spirit of the invention and the scope of the appended claims.

1. A microsampling apparatus comprising:
a sample chamber with its inside evacuated to a prespecified degree of vacuum;
a sample support stage disposed within said sample chamber, for mounting a substrate thereon;
an electron beam irradiation device operative to irradiate an electron beam onto the substrate being mounted on said sample support stage;
an electron beam detector for detecting the electron beam reflected at the substrate and for outputting a detection result;
an electrically insulative cutting tool existing over the substrate for cutting a foreign object which is electrified by irradiation of the electron beam; and
an electrically conductive sampling tool for performing, upon application of a voltage by a potential control means, sampling of the foreign object in an electrified state.

2. The microsampling apparatus according to claim 1, wherein said sampling tool performs sampling of the electrified foreign object by the voltage control.

3. The microsampling apparatus according to claim 1, wherein said cutting tool is drivable toward any one of X, Y and Z axis directions.

4. The microsampling apparatus according to claim 1, wherein said cutting tool is made of an electrically insulative material having a degree of hardness greater than or equal to Mohs hardness 6.

5. The microsampling apparatus according to claim 1, further comprising:
a terminal made of a conductive material which is electrically coupled to ground or is capable of being applied a voltage.

6. The microsampling apparatus according to claim 4, further comprising:
a potential control mechanism for enabling application of a voltage to said terminal.

7. The microsampling apparatus according to claim 1, wherein said sampling tool is a tweezers-like micro-sample grasping and holding mechanism structured from two arms.

8. A sampling method comprising the steps of:
irradiating an electron beam onto a substrate;
cutting, by a cutting tool, a foreign object on the substrate which is electrified due to irradiation of the electron beam; and
sampling, by a sampling tool, the cutting-completed electrified foreign object.

9. The sampling method according to claim 8, wherein in said step of performing sampling, the sampling is performed by control of a voltage potential of said sampling tool.

10. The sampling method according to claim 8, further comprising:
controlling, prior to said step of cutting, a potential of a surrounding part of said foreign object by use of a potential-controllable terminal.

11. The sampling method according to claim 8, wherein said cutting tool is made of an electrically insulative material with a degree of Mohs hardness greater than or equal to 6.
